(19) United States
(12) Patent Application Publication
(10) Pub. No.: US 2023/0152264 A1
(43) Pub. Date: May 18, 2023

(54) METHOD AND DEVICE FOR MEASURING HUMIDITY INDICATIVE OF MOISTURE IN A STRUCTURE

(71) Applicant: AVARA AS, Sandefjord (NO)

(72) Inventor: Rudy Steen JOHANSEN, Stavern (NO)

(73) Assignee: AVARA AS, Sandefjord (NO)

(21) Appl. No.: 17/913,636

(22) PCT Filed: Mar. 17, 2021
(86) PCT No.: PCT/EP2021/056850

§ 371 Date: Sep. 22, 2022

(30) Foreign Application Priority Data
Mar. 23, 2020 (SE) 2050315-7

(51) Int. Cl. G01N 27/04; G01N 27/22

(52) U.S. Cl. CPC G01N 27/048; G01N 27/223

(57) ABSTRACT

A device for measuring humidity indicative of moisture in a structure, wherein the device includes: a non-embedded housing accommodating humidity sensor electronics of a humidity sensor, a battery, and wireless communication means, wherein the battery is adapted to power the humidity sensor and the wireless communication means, and wherein the wireless communication means is adapted to wirelessly transmit measurement data of the device to a remote apparatus; and a tubular element extending from the housing, wherein the tubular element is arrangeable in a hole in the structure, and wherein the tubular element forms a channel adapted to provide air (A), which air is affectable by moisture (M) of the structure via at least one opening in the tubular element, to a humidity sensor element of said humidity sensor. A system including a plurality of such devices, and a method for measuring humidity indicative of moisture in a structure.

### TECHNICAL FIELD

The present invention relates to a method for measuring humidity indicative of moisture in a structure, for example in a structure of a recreational vehicle or a caravan. The present invention also relates to a device for measuring humidity indicative of moisture in a structure, and to a system comprising a plurality of such devices.

### BACKGROUND

One of the costliest damages that can happen to a recreational vehicle or caravan is ingress of water causing moisture (dampness) in the floor, walls, and ceiling/roof of the recreational vehicle or caravan. This often leads to extensive and expensive repairs, bad smell, and a large decrease in value when reselling the recreational vehicle or caravan.

Manufacturers of recreational vehicles and caravans issue guarantees with respect to ingress of water, but the guarantee requires a yearly check of any presence of moisture. Insurance companies also has insurances that covers ingress of water, but with the same requirement of check-up.

However, water ingress check-ups (inspections) are costly, and requires that the recreational vehicle or caravan is in the workshop or that service personnel comes to the recreational vehicle or caravan.

Overall, one can say that damages due to moisture is the recreational vehicle/caravan industry’s unsolved problem.

### SUMMARY OF THE INVENTION

It is an object of the present invention to overcome or at least alleviate the aforementioned problem(s), and to provide an improved method and device for (indirectly) measuring moisture in a structure of especially a recreational vehicle or caravan.

According to a first aspect of the present invention, this and other objects is achieved by a method for measuring humidity indicative of moisture in a structure, wherein the method comprises: providing a measuring device comprising a housing and a tubular element, wherein the housing accommodates humidity sensor electronics of a humidity sensor of the measuring device, a battery, and wireless communication means, wherein the battery is adapted to power the humidity sensor and the wireless communication means, wherein the wireless communication means is adapted to wirelessly transmit measurement data of the measuring device to a remote apparatus, wherein the tubular element extends from the housing and forms a channel adapted to provide air, which air is affected by moisture of the structure via at least one opening in the tubular element, to a humidity sensor element of said humidity sensor, wherein the tubular element of the measuring device is arranged in a hole of the structure, wherein the housing of the measuring device is positioned on or over a surface of the structure surrounding said hole of the structure and exposed to ambient air, except (possibly) a surface of the housing facing said surface of the structure; and measuring the humidity of the moisture-affected air, which humidity is indicative of moisture in the structure, using the humidity sensor of the measuring device, while the tubular element of the measuring device is arranged in the hole of the structure and while the housing of the measuring device is positioned on or over said surface of the structure surrounding said hole of the structure and exposed to ambient air, except (possibly) the surface of the housing facing said surface of the structure.

According to a second aspect of the invention, there is provided a device for measuring humidity indicative of moisture in a structure, wherein the device comprises: a non-embedded housing accommodating humidity sensor electronics of a humidity sensor of the device, a battery, and wireless communication means, wherein the battery is adapted to power the humidity sensor and the wireless communication means, and wherein the wireless communication means is adapted to wirelessly transmit measurement data of the device to a remote apparatus; and a tubular element extending from the housing, wherein the tubular element is arrangeable in a hole in the structure, and wherein the tubular element forms a channel adapted to provide air, which air is affectable by moisture of the structure via at least one opening in the tubular element, to a humidity sensor element of said humidity sensor. This aspect may exhibit the same or similar features and technical effects as the first aspect, and vice versa.

‘Non-embedded’ may mean that the housing, also in normal use when humidity/moisture is measured, never is embedded in the structure. Instead, the housing may be position on or over a surface of the structure surrounding the aforementioned hole in which the tubular channel is (to be) arranged. Apart from the housing surface facing said surface of the structure, the housing may remain exposed to the ambient (air) when humidity/moisture is measured by the device.

The present invention is based on the understanding that humidity indicative of moisture in a structure, for example the floor or wall or ceiling of a recreational vehicle or caravan, readily can be measured - preferably continuously or repeatedly - using the battery driven and wirelessly communicating measuring device(s) as defined hereinabove. In this way, the aforementioned yearly inspections can be avoided.

Also, since humidity/moisture is measured using the tubular element arranged in a hole of the structure, i.e. inside the structure, a water leak may be detected before it is noticeable on the outside of the structure, whereby damage due to moisture, and subsequent mould and rot damage, can be reduced or eliminated. For example, (humidity caused by) moisture in a structure with aluminium plates on both sides can easily be measured with the present method and device, something that is not possible with typically used manual measurements in recreational vehicles and caravans.

Furthermore, since only the tubular element of the measuring device is arranged in a hole of the structure, whereas the housing of the measuring device is on the outside of the structure, the measuring device a) can be mounted on a relatively thin surface component (e.g. 1-6 mm) followed by some insulation material or woodwork of the structure, b) can easily be retrofitted to a structure of an existing recreational vehicle or caravan, and c) requires a relatively small hole in the structure, thereby having little effect on the structure.

Also, since the housing is exposed on the outside of the structure, the housing can readily be accessed without having to uncover the housing, for example when changing the battery.

It can be noted that US20140216143, unrelated to recreational vehicles and caravans, discloses a body part comprising an embeddable tube separating a space and at least one hole or opening or the like. An upper part of the body part is provided such that data and energy transferring electronics for e.g. data and energy transfer fits inside. A sensor is connected with the electronics and located in such a way that it can measure the moisture content in the separated space. A water vapor penetrating filter placed to protect the sensor and the electronics from extraneous substances.

However, the body part in US20140216143 is embedded in a material to be measured during its casting such that the distal end surface of the upper part is provided in the same level with the surface of the material. And in the measuring process when the structure is in normal use, the body part has been covered with insulation material and/or coating, as can be seen in FIG. 3 of US20140216143. Hence, the body part in US20140216143 is mounted in a completely different way than the present measuring device.

The present humidity sensor may be a capacitive humidity sensor or a resistive humidity sensor, for example.

The humidity sensor element (of the humidity sensor) may be arranged in the housing.

As indicated above, the structure may be included in a recreational vehicle (motorhome) or a caravan. The structure may for example be the floor or a wall or the ceiling of the recreational vehicle or caravan. Alternatively, the structure could be included in some other mobile unit, such as an isolated trailer (for refrigerated transport), an isolated container, etc. Basically, the present invention could be used for any type of wall, floor, or ceiling/roof (-’structure”) where moisture damage could occur.

As indicated above, the humidity may be measured continuously or repeatedly, for example once every second day.

Furthermore, a surface of the housing surrounding the tubular element may be provided with adhesive means. The adhesive means may for example be a double sided (foam) tape, but other adhesive means - such as glue - could be used as well. Apart from facilitating mounting of the (measuring) device to the structure, the present inventor has realized that the adhesive means also may prevent that the humidity of the ambient air (negatively) affects the measurement, which in turn provides for a more accurate measurement. To this end, the adhesive means preferably forms a continuous area around the tubular element. In other words, the adhesive means/continuous area acts as a seal between the ambient air and the hole in the structure.

The at least one opening in the tubular element may be a plurality of longitudinal slots. As the slots are longitudinal, the humidity measurement can be influenced by moisture from a range of depths (corresponding to the length of the longitudinal slots) possibly covering different layers in the structure. Furthermore, the plurality of longitudinal slots could be (uniformly) distributed about the circumference of the tubular element, whereby the humidity measurement can be influenced by moisture from different directions.

A portion of the tubular element closest to the housing may be circumferentially closed and devoid of said at least one opening. This portion of the tubular element may for example be an open or hollow cylinder. This portion has several advantages. It may allow measurement in the right place (depth) in the structure. Furthermore, it may protect the humidity sensor element from debris from the structure. Furthermore, it may allow this portion of the tubular element to function as an integrated humidity chamber, thereby forming an air gap (with the moisture-affected air) between the humidity sensor element and the structure.

A free end portion of the tubular element opposite the housing may be pointed. This may serve to centre the tubular element and the humidity sensor element when the tubular element of the (measuring) device is inserted in the hole in the structure.

The housing may include a partition such that the humidity sensor element is exposable for the air affectable by moisture of the structure but not the humidity sensor electronics, battery, and wireless communication means. This may ensure proper functionality and prolong the lifetime of the humidity sensor electronics, battery, and wireless communication means. The partition is conveniently formed by a portion of a printed circuit board in the housing, on which portion the humidity sensor element is mounted, and a ring-shaped element surrounding the humidity sensor element. Hence, no filter in front of the humidity sensor element is needed in the present (measuring) device.

According to a third aspect of the invention, there is provided a system, comprising: a plurality of devices according to the second aspect of the invention; and a remote apparatus comprising communication means adapted to receive measurement data wirelessly from the plurality of devices and to transmit the received measurement data wirelessly to a server.

The devices may be mounted to different structures of a recreational vehicle or caravan, for example one or more devices in the floor, one or more devices in the walls, and one or more device in the celling.

The server, which may be included in the system, may be adapted to receive the measurement data transmitted by the remote apparatus, and to detect if a water leak has occurred based on relative humidity data in the received measurement data. The server may for example detect that a water leak has occurred if the relative humidity data in the measurement data of at least one of the devices exceeds a threshold, for example 80% RH.

The measurement data of each device may be accompanied by a device identifier, wherein the server further is adapted to detect where a water leak has occurred based on the device identifiers. The server may here consult a record which specifies to which structure (e.g. the floor, a wall, or the ceiling of a recreational vehicle or caravan) each device is mounted.

To improve the accuracy of the water leak detection, the server may take into account natural fluctuations in humidity, preferably by comparing the relative humidity data of each device to an average of the relative humidity data of all of the plurality of devices and/or the ambient air humidity (measured e.g. by a conventional hygrometer) at a given time. For example, if the relative humidity measured by one of the devices increases from one time to another to a high level, generally indicating a water leak, it may be that the later measurement does not deviate significantly from the average measured relative humidity at that time because of more humid weather, whereby the server may refrain from detecting that a water leak has occurred. In another example, if the relative humidity measured by one of the devices is constant from one time to another, generally indicating no water leak, it may be that the later measurement is significantly higher than the average measured relative humidity at that time, which average has decreased because of dryer weather, whereby the server nevertheless may detect that a water leak has occurred.

The measurement data may further comprise temperature data provided by a temperature sensor in each device, wherein the server is adapted to detect a water leak or (potential) moisture damage taking into account at least one dew point calculated based on the relative humidity data and the temperature data in the received measurement data. By measuring both relative humidity and temperature, it is possible to calculate when condensation occurs (dew point). For example, 60% RH in warm weather may not result in condensation, whereas 60% RH in cold weather may result in condensation, wherein condensation increases the risk of moisture damage. Hence, in the former case the sever may not “detect” (potential) moisture damage, but in the latter detect (potential) moisture damage for the same RH, which leads to accurate (potential) moisture damage detection.

The server further may further be adapted to issue or cause issuance of an alarm if it detects that a water leak (or moisture damage) has occurred. The alarm may for example be issued as a message or notification to a smartphone or the like of the owner of a recreational vehicle or caravan in which the system is installed. The server may further be adapted to issue, or cause issuance of, a warning if the relative humidity data in the measurement data of at least one of the devices exceeds a lower threshold, for example 60% RH. The warning may likewise be issued as a message or notification to a smartphone or the like of the owner of a recreational vehicle or caravan in which the system is installed.

### BRIEF DESCRIPTION OF THE DRAWINGS

These and other aspects of the present invention will now be described in more detail, with reference to the appended drawings showing a currently preferred embodiment of the invention.

FIG. 1a is a cross-sectional perspective view of a measuring device according to an embodiment of the second aspect of the present invention.

FIG. 1b shows an enlarged detail of the measuring device in FIG. 1a.

FIG. 2 is a perspective view, slightly from below, of the measuring device of FIGS. 1a-b.

FIG. 3 is a bottom view of the measuring device of FIGS. 1a-b.

FIG. 4 is a cross-sectional perspective view of the measuring device of FIGS. 1a-b, when mounted to a structure.

FIG. 5 is a flowchart of a method according to an embodiment of the first aspect of the present invention.

FIG. 6 illustrates a system according to an embodiment of the third aspect of the present invention, which system is installed in a recreational vehicle.

### DETAILED DESCRIPTION

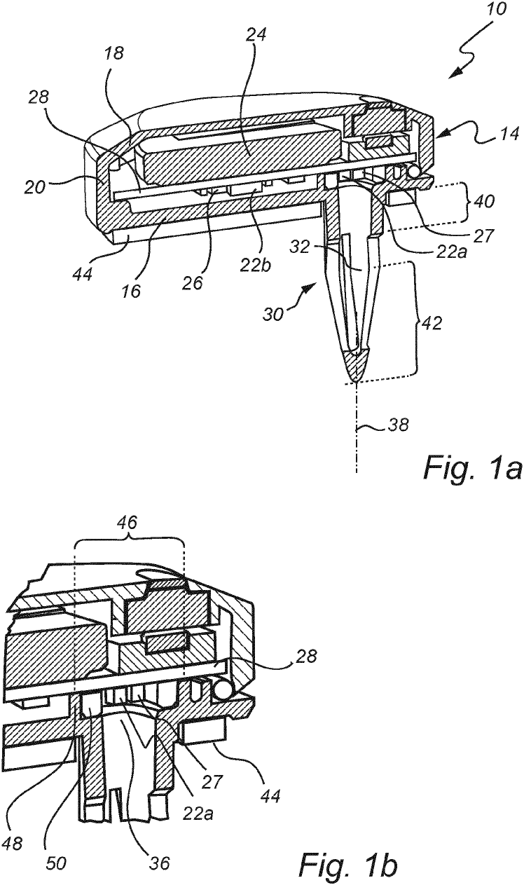

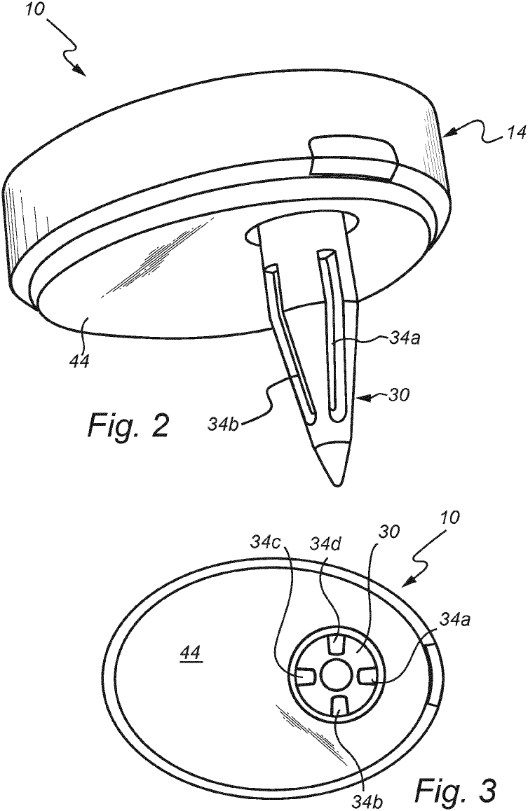

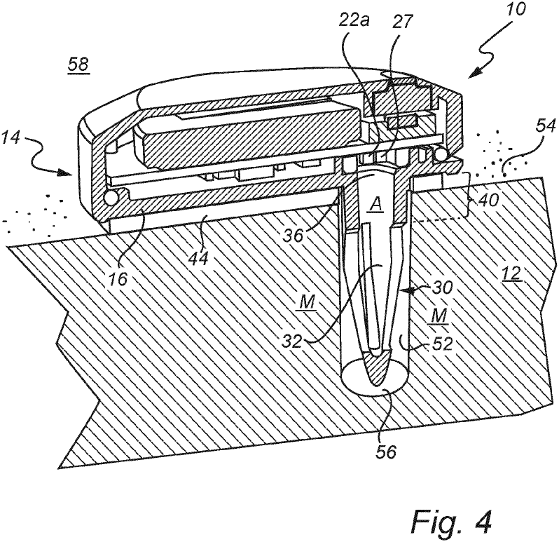

FIGS. 1a-b and 2-3 illustrate a device 10 for measuring moisture in a structure 12 (the structure 12 is shown in FIG. 4).

The device 10, which may also be referred to as a measuring device 10, comprises a housing 14. The housing 14 may be shaped substantially like a disk or puck or (low) cylinder. The housing 14 has a flat underside 16, a top side 18, and a side wall 20 connecting the flat underside 16 and the top side 18. The top side 18 and the side wall 20 could be made in one piece, which one piece 18, 20 may be removably attached to the flat underside 16.

The housing 14 accommodates (houses) a humidity sensor 22a-b, a battery 24, and wireless communication means 26. That is, the humidity sensor 22a-b, the battery 24, and the wireless communication means 26 are provided in(side) the housing 14.

The humidity sensor is adapted to measure relative humidity (RH), whereby measurement data of the device 10 may include relative humidity data. The humidity sensor may be a capacitive humidity sensor or a resistive humidity sensor, for example. The humidity sensor includes a humidity sensor element 22a and humidity sensor electronics 22b. The humidity sensor element 22a and humidity sensor electronics 22b are mounted on, and interconnected via, a printed circuit board 28 in the housing 14. The printed circuit board 28 may be parallel to the flat underside 16.

The battery 24 is connected to, and adapted to power, the humidity sensor 22a-b and the wireless communication means 26. The battery 24 may be placed on the printed circuit board 28. The battery 24 may be replaceable, and it can be accessed by temporarily removing the aforementioned one piece 18, 20 from the flat underside 16 of the housing 14.

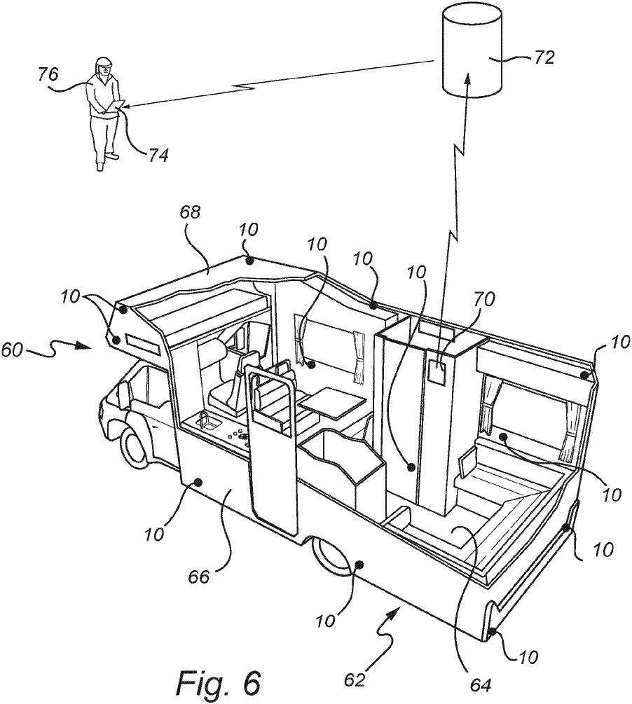

The wireless communication means 26 is adapted to wirelessly transmit the measurement data of the device 10 to a remote apparatus (FIG. 6). The wireless communication means 26 could for example be a Bluetooth unit. Alternatively, the wireless communication means 26 could be based on UHF proprietary radio, ZigBee, ANT, etc. The wireless communication means 26 may be mounted on the printed circuit board 28. An antenna of the wireless communication means 26 may be arranged along the perimeter of the printed circuit board 28.

The device 10 may further comprise a temperature sensor 27, whereby the measurement data of the device 10 may further include temperature data. The temperature sensor 27 may be position on the printed circuit board 28, near the humidity sensor element 22a.

The device 10 further comprises a tubular element 30 extending from the housing 14. Namely, the tubular element 30 extends perpendicularly from the flat underside 16 of the housing 14. The tubular element 30 may have a length in the range of 2-4 cm, preferably approximately 3 cm. The tubular element 30 may be circular in cross-section. The (maximum) diameter of the tubular element 30 may be about 6 mm.

The tubular element 30 forms a channel 32. The channel 32 is adapted to provide air A, which air A in use is affected (dampened) by moisture M of the structure 12 (see FIG. 4) via at least one opening 34a-d in the tubular element 30, to the humidity sensor element 22a in the housing 14 (via an aperture 36 in the flat underside 16 of the housing 14). The channel 32, aperture 36, and humidity sensor element 22a may be coaxially arranged.

The at least one opening 34a-d may be a plurality of longitudinal slots 34a-d. As such, the longitudinal slots 34a-d are elongated, and extend generally parallel to a (central) longitudinal axis 38 of the tubular element 30. The number of longitudinal slots 34a-d is here four, but could alternatively be two or three, for example. The longitudinal slots 34a-d may be of equal size, shape, and position, except that they are uniformly distributed about the circumference of the tubular element 30, i.e. one at 0/360 degrees, one at 90 degrees, one at 180 degrees, and one at 270 degrees (see FIG. 3). The longitudinal slots 34a-d may for example have a length in the range of 1.5-2 cm, and a width of about 1.5 mm.

A portion 40 of the tubular element 30 closest to the housing 14 is preferably circumferentially closed, and hence devoid the longitudinal slots 34a-d. In other words, the longitudinal slots 34a-d do not extend on the portion 40. The portion 40 may for example be an open or hollow (right circular) cylinder. The length of the portion 40 may for example be about 5 mm.

Furthermore, the free end portion 42 of the tubular element opposite the housing 14 may be pointed, as shown in for example FIGS. 1a and 2. The longitudinal slots 34a-d may partly extend on this pointed free end portion 42. The length of the free end portion 42 may for example be about 25 mm.

Furthermore, a surface of the housing 14 surrounding the tubular element 30, i.e. the flat underside 16, may be provided with adhesive means 44, for example a double sided foam tape. The adhesive means 44 preferably forms a continuous area around the tubular element 30, as can be seen in particular in FIG. 3. The adhesive means 44 may cover substantially the complete underside 16.

Furthermore, the housing may include a partition formed by a portion 46 of the printed circuit board 28, on which portion the humidity sensor element 22a is mounted, and a ring-shaped element 48 surrounding the humidity sensor element 22a. Namely, the ring-shaped element 48 is arranged around the aforementioned aperture 36, extends from the flat underside 16 towards the inside of the housing 14, and is closed off by said portion 46 of the printed circuit board 28, on which portion 46 the humidity sensor element 22a is mounted such that it faces and is in fluid communication with the aforementioned channel 32 of the tubular element 30. In this way, only the humidity sensor element 22a may be exposed to the (damp) air A, but not the humidity sensor electronics 22b, battery 24, and wireless communication means 26, which are either on the opposite side of the ring-shaped element 48 or on the opposite side of the printed circuit board 28. The partition may be sealed by a ring-shaped seal 50.

In use, when humidity indicative of moisture in the structure 12 is measured, the measuring device 10 is mounted to the aforementioned structure 12, see FIG. 4.

Namely, the tubular element 30 of the measuring device 10 is arranged in a hole 52 of the structure 12. The hole 52 extends from a surface 54 of the structure 12 and into the structure 12. The hole 52 may for example be a bore hole. The hole 52 usually has a bottom 56.

The housing 14 of the measuring device 10, on the other hand, is on the outside of the structure 12. Specifically, the housing 14 is positioned on the surface 54 of the structure 12 (which surface 54 thus surrounds the hole 52), whereby the housing 14 - apart from the flat underside 16 which faces the surface 54 of the structure 12 - is exposed to ambient air 58. The measuring device 10 is secured to the structure 12 by the aforementioned adhesive means 44.

Moisture M in the structure 12 affects (dampens) via at least one of the longitudinal slots 34a-d the air A in the channel 32 between the structure 12 and the humidity sensor element 22a (especially at portion 40). In other words, the concentration of water vapour present in the (damp) air A is influenced by the moisture M in the structure 12. The channel 32 provides the damp/dampened air A via the aperture 36 to(wards) the humidity sensor element 22a, whereby the humidity in the air A indicative of moisture in the structure 12 may be measured using the humidity sensor. The adhesive means 44/continuous area may act as a seal between the ambient air 58 and the hole 52 in the structure 12, which in turn provides for a more accurate measurement.

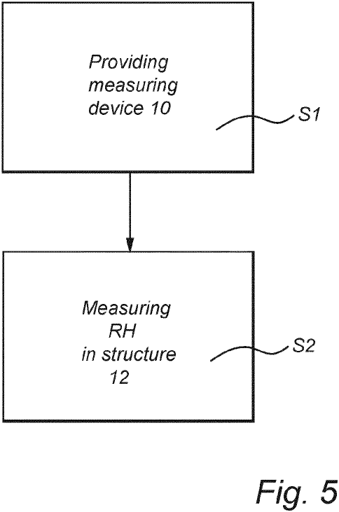

A method for measuring humidity indicative of moisture in the structure 12 may (hence) comprise: providing the measuring device 10 (S1 in FIG. 5), wherein the tubular element 30 of the measuring device 10 is arranged in the hole 52 of the structure 12, and wherein the housing 14 of the measuring device 10 is positioned on the surface 54 of the structure 12 surrounding said hole 52 and exposed to ambient air 58, except the flat underside 16 of the housing 14 facing the surface 54; and measuring humidity (S2) indicative of moisture in the structure 12 using the humidity sensor 22a-b, while the tubular element 32 is arranged in the hole 52 and while the housing 14 is positioned on the surface 54 and exposed to the ambient air 58, except the flat underside 16.

FIG. 6 illustrates a system 60 comprising a plurality of measuring devices 10 of the type described above. The system 60 is installed in a recreational vehicle 62. The measuring devices 10 may for example be mounted on the floor 64, in the walls 66, and in the ceiling 68 of the recreational vehicle 62. In the illustrated embodiment, the system 60 comprises twelve measuring devices 10, but it could comprise more or fewer measuring devices 10.

The measuring devices 10 may be installed then the recreational vehicle 62 is manufactured, or they could be retrofitted to an existing recreational vehicle 62. A measuring device 10 may be installed by drilling a suitable hole 52 in the structure (floor, wall, ceiling) to be measured, then a protection of the double sided foam tape adhesive means 44 is peeled off, and then the tubular element 30 is inserted into the hole 52 until the housing 14 is stopped by the surface 54 and the measuring devices 10 is secured to the structure in questions by the double sided foam tape adhesive means 44. Since the measuring devices 10 are battery driven and communicate wirelessly, no wiring is needed.

The system 60 further comprises a remote apparatus 70 in the form of a modem. The modem 70 may be paired with the measuring devices 10. The modem 70 is adapted to receive measurement data wirelessly from the plurality of devices 10 sent by the wireless communication means 26, and to transmit the received measurement data wirelessly to a server 72. The modem 70 may be a mobile broadband modem (wireless modem), for example based on 5G. The modem 70 is also installed in the recreational vehicle 62.

The server 72 may be adapted to receive the measurement data transmitted by the modem 70, and to detect if a water leak has occurred in the recreational vehicle 62.

In use, the devices 10 continuously or repeatable measure relative humidity in the floor 64, walls 66, and ceiling 68 of the recreational vehicle 62, and transmits the measurement data to the modem 70, which relays the measurement data to the server 72. The (twelve) devices 10 may for example measure the relative humidity once every second day.

Except relative humidity data, the measurement data can include temperature data provided by the temperature sensor 27 in each device 10. Furthermore, the measurement data may be accompanied by a device identifier and a time stamp. Hence an exemplary data transmission from one of the devices 10 could be device identifier = lD1, time stamp = 2020-03-17 11:06, relative humidity data (=measured (relative) humidity) = 35 RH%, and temperature data = 17° C.

The server 72 detects if a water leak has occurred in the recreational vehicle 62 based on the relative humidity data in the received measurement data. The server 72 may for example detect (estimate) that a water leak has occurred in the ceiling 68 of the recreational vehicle 62 if the relative humidity data in the measurement data from at least one measuring device mounted to the ceiling 68 exceeds a first threshold. The first threshold may for example be set in the range of 60-80% RH.

To improve the accuracy of the water leak detection, the server 72 may take into account natural fluctuations in humidity by comparing the relative humidity data of each device 10 to an average of the relative humidity data of all the devices 10 and/or the ambient air humidity (measured e.g. by a conventional hygrometer; not shown) at a given time. For example, if the relative humidity measured by one of the devices 10 increases from one time t1 to another t2 from say 20% RH to 65% RH, generally indicating a water leak, it may be that the later measurement at t2 does not deviate significantly from the average measured relative humidity (e.g. 60% RH) at that time t2 because of more humid weather, whereby server 72 may refrain from detecting that a water leak has occurred. In another example, if the relative humidity measured by one of the devices 10 is constant (e.g. about 40% RH) from one time t1 to another t2, generally indicating no water leak, it may be that the later measurement at t2 is significantly higher than the average measured relative humidity (e.g. 15% RH) at that time t2, which average has decreased because of dryer weather, whereby the server 72 nevertheless may detect that a water leak has occurred.

The server 72 may also detect a water leak or (potential) moisture damage in the recreational vehicle 62 taking into account at least one dew point calculated based on the relative humidity data and the temperature data in the received measurement data. Dew point may be defined as the temperature at which a vapor (such as water) begins or would begin to condense. The server 72 may for example detect potential moisture damage if the temperature of the temperature data is below the calculated dew point, but not if the temperature of the temperature data is above the calculated dew point for the same measured relative humidity value.

The server 72 may further issue, or cause issuance of, an alarm if the server 72 detects that a water leak or moisture damage has occurred in the recreational vehicle 62. The alarm may for example be issued as a message (e.g. e-mail and/or SMS) or notification to a smartphone 74 or the like of the owner 76 of the recreational vehicle 62.

The server 72 may further issue, or cause issuance of, a warning to the owner 72 if the relative humidity data in the measurement data of at least one of the devices 10 exceeds a second, lower threshold. The second, lower threshold could be set in the range of 40-60% RH, for example.

The person skilled in the art realizes that the present invention by no means is limited to the embodiments described above. On the contrary, many modifications and variations are possible within the scope of the appended claims. For example, the humidity sensor element 22a could alternatively be placed a short distance into the channel of the tubular element.

1-17. (canceled)

18. A method for measuring humidity indicative of moisture in a structure included in a recreational vehicle or a caravan, wherein the method comprises:
providing a measuring device comprising a housing, a humidity sensor, a battery, wireless communication means, and a tubular element, wherein the housing accommodates humidity sensor electronics of the humidity sensor of the measuring device, the battery, and the wireless communication means, wherein the battery is adapted to power the humidity sensor and the wireless communication means, wherein the wireless communication means is adapted to wirelessly transmit measurement data of the measuring device to a remote apparatus, wherein the tubular element extends from the housing and forms a channel adapted to provide air, which air is affected by moisture of the structure via at least one opening in the tubular element, to a humidity sensor element of said humidity sensor,
wherein the tubular element of the measuring device is arranged in a hole of the structure included in the recreational vehicle or caravan,
wherein the housing of the measuring device is positioned on or over a surface of the structure surrounding said hole of the structure and exposed to ambient air, except possibly a surface of the housing facing said surface of the structure; and
measuring the humidity of the moisture-affected air, which humidity is indicative of moisture in the structure, using the humidity sensor of the measuring device, while the tubular element of the measuring device is arranged in the hole of the structure and while the housing of the measuring device is positioned on or over said surface of the structure surrounding said hole of the structure and exposed to ambient air, except possibly the surface of the housing facing said surface of the structure
wherein the housing has a flat underside,
wherein the housing includes a partition such that the humidity sensor element is exposable for the air affectable by moisture of the structure but not the humidity sensor electronics, battery, and wireless communication means,
wherein the device further comprises a printed circuit board in the housing and a ring-shaped element surrounding the humidity sensor element,
wherein the printed circuit board is parallel to the flat underside,
and wherein the partition is formed by a portion of the printed circuit board in the housing, on which portion the humidity sensor element is mounted, and the ring-shaped element surrounding the humidity sensor element.

19. A method according to claim 18, wherein the humidity is measured continuously or repeatedly.

20. A device for measuring humidity indicative of moisture in a structure, wherein the device comprises:
a humidity sensor;
a battery;
wireless communication means;
a housing accommodating humidity sensor electronics of the humidity sensor of the device, the battery, and the wireless communication means, wherein the battery is adapted to power the humidity sensor and the wireless communication means, wherein the wireless communication means is adapted to wirelessly transmit measurement data of the device to a remote apparatus; and
a tubular element extending from the housing, wherein the tubular element is arrangeable in a hole in the structure, and wherein the tubular element forms a channel adapted to provide air, which air is affectable by moisture of the structure via at least one opening in the tubular element, to a humidity sensor element of said humidity sensor,
wherein the housing has a flat underside and is positionable on or over a surface of the structure surrounding said hole,
wherein the housing includes a partition such that the humidity sensor element is exposable for the air affectable by moisture of the structure but not the humidity sensor electronics, battery, and wireless communication means,
wherein the device further comprises a printed circuit board in the housing and a ring-shaped element surrounding the humidity sensor element,
wherein the printed circuit board is parallel to the flat underside,
and wherein the partition is formed by a portion of the printed circuit board in the housing, on which portion the humidity sensor element is mounted, and the ring-shaped element surrounding the humidity sensor element.

21. A device according to claim 20, wherein a surface of the housing surrounding the tubular element is provided with adhesive means.

22. A device according to claim 21, wherein the adhesive means forms a continuous area around the tubular element.

23. A device according to claim 20, wherein said at least one opening in the tubular element is a plurality of longitudinal slots.

24. A device according to claim 20, wherein a portion of the tubular element closest to the housing is circumferentially closed and devoid of said at least one opening.

25. A device according to claim 20, wherein a free end portion of the tubular element opposite the housing is pointed.

26. A system, comprising:
a plurality of devices according to claim 20;
a server; and
a remote apparatus comprising communication means adapted to receive measurement data wirelessly from the plurality of devices and to transmit the received measurement data wirelessly to the server.

27. A system according to claim 26, wherein the server is adapted to receive the measurement data transmitted by the remote apparatus, and to detect if a water leak has occurred based on relative humidity data in the received measurement data.

28. A system according to claim 27, wherein the measurement data of each device is accompanied by a device identifier, and wherein the server further is adapted to detect where a water leak has occurred based on the device identifiers.

29. A system according to claim 27, wherein the server is adapted to detect if a water leak has occurred further taking into account natural fluctuations in humidity by comparing the relative humidity data of each device to an average of the relative humidity data of all of the plurality of devices and/or the ambient air humidity measured by a conventional hygrometer at a given time.

30. A system according to claim 27, wherein each device comprises a temperature sensor, and wherein the measurement data further comprises temperature data provided by the temperature sensor in each device, and wherein the server is adapted to detect a water leak or moisture damage taking into account at least one dew point calculated based on the relative humidity data and the temperature data in the received measurement data.

31. A system according to claim 27, wherein the server further is adapted to issue or cause issuance of an alarm if it detects that a water leak has occurred.
